(19) United States
(12) Patent Application Publication
(10) Pub. No.: US 2016/0294787 A1
(43) Pub. Date: Oct. 6, 2016

(54) SECURE AND CONFIDENTIAL MESSAGING SYSTEMS

(71) Applicant: HEY APP PTY LTD., Southport (AU)

(72) Inventors: Daniel Moore, Molendinar (AU); Henry Hardy, Robina (AU)

(21) Appl. No.: 15/090,561

(22) Filed: Apr. 4, 2016

Related U.S. Application Data
(60) Provisional application No. 62/142,750, filed on Apr. 3, 2015.

(51) Int. Cl. H04L 29/06; H04L 12/58

(52) U.S. Cl. CPC H04L 63/0428; H04L 51/24; H04L 63/102

(57) ABSTRACT

A secure messaging system that allows a user to display incoming messages that appear in the same format as outgoing message, that have no identifying information to identify the sender or recipient of any message displayed, and that deletes messages after the messages have been read. The secure messaging system also allows usernames in a contacts application to be identified using nicknames.

### CROSS-REFERENCE TO RELATED APPLICATIONS

The present application claims the benefit of priority to U.S. Provisional Patent Application Ser. No. 62/142,750, filed Apr. 3, 2015 and which is hereby incorporated by reference in its entirety.

### TECHNICAL FIELD

The present invention relates generally to systems and methods for communicating messages over communications networks, and more particularly to systems and methods for communicating messages that are confidential and secure.

### BACKGROUND

Electronic mail (email) and text messaging applications have become standard applications on smartphones. Most smartphones also include cameras allowing users to take pictures on their smartphones, exchange the images using email and text messaging applications, and upload images to social media sites or other sites on the Internet. Desktop or laptop workstations also typically include email applications and other messaging applications as standard work and personal communication tools.

Communicating by sending written messages and images or video clips has become as common as talking by phone. An ongoing concern with communicating by messaging is the potential for having one's privacy violated. Computer networks are constantly being targeted by hackers who are able to break into the computers and user accounts used to store the users' email and messages, as well as photos and other media. Email and messaging system providers have tried to address the danger posed by computer hackers primarily by adding encryption and other security features.

Current solutions focus on the backend of messaging systems and do not address the user interface. Message conversations often end up in images taken using the screen capture feature on smartphones. It is not possible on current smartphones to override the screen capture feature. A screen capture of a messaging dialog can be stored and its privacy compromised by being communicated on social media or made public by hackers.

In view of the foregoing, there is an ongoing need for messaging systems that address privacy and confidentiality at a user interface level.

### SUMMARY

In view of the above, a messaging system and method are provided to ensure secure and confidential communication of messages, such as text messages, emails, and other such message types. In an example of a method for displaying messages on a display device operating in a computing device having a processor, the method comprises receiving an incoming message for display on the display device, identifying a sender username of a sender of the incoming message by searching for a username identifier in the incoming message, and searching a contacts list stored in memory connected to the computing device for a username matching the sender username.

The contacts list comprises a plurality of contacts including a contact username editable to be changed to a nickname by the user of the computing device. The nickname corresponding to the sender username is retrieved, and a message notification is displayed on the display device indicating the user has an incoming message from the sender identified by the nickname. A user input is received indicating a display instruction to display the incoming message. The message is displayed without displaying any information identifying the sender username. The message is displayed using a message display format that is used for a message editor display when the user of the computing device edits a message. When a user input is received to change the display from displaying the incoming message, the incoming message is deleted when the display is changed from displaying the incoming message.

In an example messaging system, messaging system operates on a computing device having a processor. A user interface is connected to a display device configured to display images and text. The system includes a messaging application configured to receive incoming messages and a message editor for preparing outgoing messages, to provide the incoming messages and the message editor display using a message display format that displays incoming messages and outgoing messages with the same format and appearance. Incoming and outgoing messages are displayed without displaying any information identifying a sender of the incoming message or a username of the user. Incoming messages are deleted when the messaging application receives a user input that changes the display.

The system includes a contacts application configured to provide an image to display contact entries by either username, or by a nickname editable by the user to replace the username in the display of the contact entries.

Various advantages, aspects and novel features of the present invention, as well as details of an illustrated embodiment thereof, will be more fully understood from the following description and drawings.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic diagram of an example of a messaging system displaying a contacts list on an example of a computing device.

FIG. 2 is a schematic diagram of the example of the messaging system in FIG. 1 displaying a message the computing device.

FIG. 3 is a flow diagram illustrating changes to the user interface in response to user input to a messaging application in the messaging system.

FIGS. 4 & 5 show the display screen on the computing device illustrating operation of a feature for enabling anonymous messaging.

### DETAILED DESCRIPTION

Examples of a secure and confidential messaging system are described below. Examples of the messaging system may be implemented on any suitable computing device. Implementations of the messaging system may find particularly advantageous use on mobile computing devices, such as smartphones, tablet computers, or laptops, or on desktop computers. The messaging system may be offered as an application to be installed on the computing device from either a disk or from an image that may be downloaded over the Internet from an app store. The messaging system application may be installed on the user's computing device and integrated with the user environment on the computing device. For example, the user may configure a messaging application profile containing information about the user that the user may access and display under the user's control protected by a password, for example. The user's profile may be linked to a messaging application account.

Example implementations of the messaging system provide added security and confidentiality to a user's messaging activity by:
1 Ensuring that the name of any user, whether as sender or receiver of a message, never appears on the computing device display when the message is displayed.
2 Ensuring the incoming messages and outgoing messages look exactly the same.
3 Deleting messages after they are read.
4 Allowing the user to replace the contact username of a contact in the user's contact list with a nickname.
   Example implementations of the messaging system include these four requirements within an application that may operate for example as a client on the computing device connected over the Internet to a messaging server. The messaging system may be implemented as a messaging application with an interface to a separate contacts application, a messaging application and contacts application in one app, or a messaging application and contacts application that are separate but intended to operate together.

The secure and confidential messaging system may be implemented in the context of a community of users who wish to communicate completely privately with one another with built-in features that assure privacy and confidentiality. The messaging system may be implemented with encryption capabilities. However, added security and confidentiality may be provided with security features provided in example implementations described below. In the context of the private community, members of the community may be designated to include any user having the messaging system on his or her computing device. The contact information may include an indicator that indicates whether or not the user identified by a nickname is a “member” of the private community, or otherwise uses the app. When users add one another to their contacts list, the member indicator on the contact information in each other's contacts list may be set to reflect that they are members of the community.

The features and capabilities summarized above will become clearer in light of the detailed description below of example implementations of the secure and confidential messaging system.

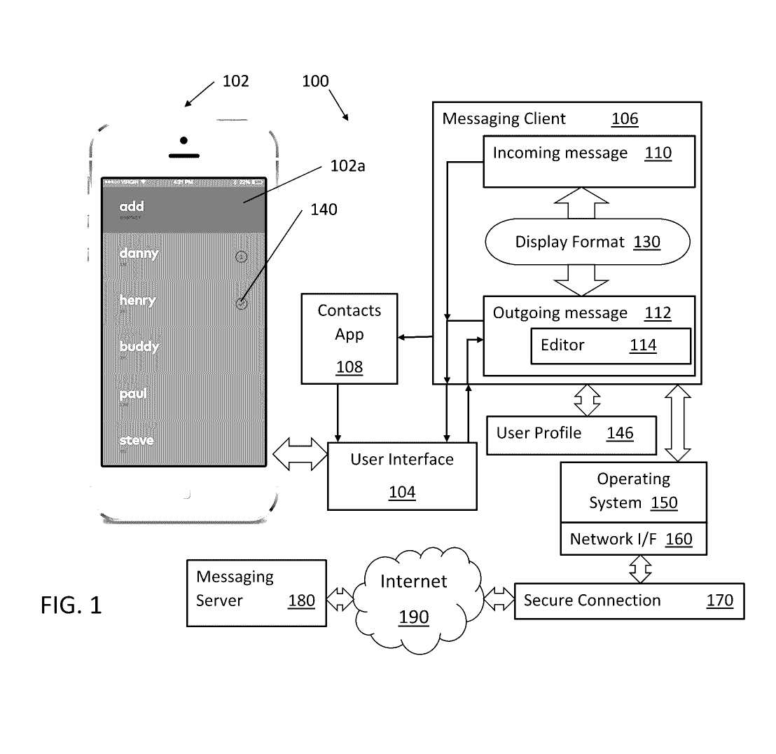

FIG. 1 is a schematic diagram of an example of a messaging system 100 operating on a computing device 102 having a display device 102a. The computing device 102 in FIG. 1 is a smartphone, such as for example, an iPhone®, a device that operates using the Android® operating system, or any other similar mobile phone with computing capabilities. It is to be understood that the computing device 102 may also be a desktop computer, a laptop computer, or a tablet computer such as, for example, an iPad®.

The messaging system 100 includes a user interface 104 to provide output to the display device 102a and to receive input. In the display device 102a shown in FIG. 1, the display device 102a is a touchscreen used for user input by touching areas of the display device 102a having a context indicated by the display. In other example implementations, the user interface 104 may receive input from a keypad, a keyboard, a mouse, a trackball, or any other suitable input device.

The messaging system 100 also includes a messaging application 106 and a contacts application 108. It is noted that the messaging system 100 may be implemented in a text messaging application similar to standard text messaging applications provided on most smartphones. The messaging system 100 may also be implemented in an email system operating as an email client application. The messaging system 100 may also operate as a messaging app for social media sites such as Facebook®, for example.

The computing device in the system illustrated in FIGS. 1-5 is a smartphone, such as an iPhone® or an Android device, however implementations of the messaging system 100 are not limited to smartphones. The messaging application 106 and the contacts application 108 are applications operating under a smartphone operating system 150, such as the iOS or the Android operating system. The operating system 150 includes a network interface 160 for communication over the Internet 190. The operating system 150 in the example in FIG. 1 further includes the capability of establishing secure connections 170 over the Internet 190 to a messaging server 180 using, for example, encryption and decryption algorithms. The secure connections 170 may be used to communication incoming and outgoing messages to and from the messaging application 106.

The messaging application 106 receives an incoming message 110 and communicates an indication of the incoming message 110 to the contacts application 108 with an identifier of a sender username. When the user provides an input, for example, by tapping on the screen of the display device 102a in an area displaying a context for the input indicating an instruction to display the message, the messaging application 106 communicates the message contents to the user interface 104 with a message display format 130. The message display format 130 provides display specifications for displaying the message. The display specifications may include a font, text color, background color, special character formats (e.g. bold, italics, etc.), text character size, and other similar types of specifications. In one example implementation, messages may be displayed with the display changing in an animated way according to an animation style. For example, when a message is being removed from the display, the user interface 104 may control the display 102a to show the message disintegrating on the screen into bits, or the message can be shown to swoosh into a corner, or the message can be removed in some other animated way.

The messaging application 106 also provides an editor 114 to permit a user to compose an outgoing message 112. The editor 114 receives text input from the user interface 104, which receives the text input when the user presses images of letters displayed on the screen of a touchscreen interface, or when the user enters the characters on an attached keypad or keyboard. The appearance of the screen as the editor 114 is used is determined by the display format 130, which comprises the same display specifications used for displaying the incoming message. When the editor 114 is activated, the screen on the display device 102a is made blank in a background color dictated by the display format 130. As the user enters input, the characters appear in the text color dictated by the display specifications in the display format 130. The size of the text is also dictated by the specifications in the display format 130. The same display format 130 is used for both outgoing messages and incoming messages so that one would not be able to determine whether the display shows an incoming message or an outgoing message by looking at the display.

The messaging application 106 is also configured to delete a message on the display device 102a when the user enters an input that requires the display to change. For example, when the incoming message 110 is displayed (with no username or other sender identifier), the user may read the message and then either exit out of the messaging application 106, or wipe the display, or perform some action on the screen indicative of a desire to change the image on the display. Upon receiving the input indicative of the user's action, the messaging application 106 deletes the incoming message 110. The message is deleted such that the computing device 102 no longer contains any trace of ever having received the message. Where the messaging application 106 operates in an email environment, the message is deleted anywhere it can be stored, such as an inbox. No copy is maintained in any archive, nor in any backup system. In a text messaging environment, no dialog of messages with the sender user is maintained.

The messaging application 106 and/or the contacts application 108 may have access to a user profile 146, which may be a user's profile that is configured by the user specifically for using the messaging application 106. The user profile 146 may also be a set of information about the user that is maintained in the computing device for all applications the computing device to access. The user profile 146 may include settings or configuration data to access features of the messaging application 106. For example, the messaging application 106 and/or the contacts application 108 may include, but is not limited to, the following options:
1 a personal identification number (“PIN”)—a code or a password that the user can create to enable access to the application(s). For example, the user may launch the messaging application 106 and before transferring operation to the messaging application 106, a request for entry of the user's PIN may be displayed. Transfer to operation of the messaging application 106 is disabled until the user enters the correct PIN number.
2 a secondary personal identification number (“PIN2”)—a second PIN that may be used as an emergency PIN that directs a user to a false profile. The secondary PIN, or PIN2, may be used as a password that can be provided to someone with physical access to the user's computing device that requests the user's PIN or password. Entry of the PIN2 transfer operation of the messaging application linked to a phony application account with no incoming messages and listing false contacts in the contact list. The PIN2 allows the user to present a false impression of the user's use of the messaging application.
3 Message Expiration Time—a self-destruct timer to be attached to a message the user sends to a recipient that causes the message to sit in the recipient's inbox, or have a new message indicator in the contacts list indicate a new message, for only a predetermined amount of time before the message deletes itself.

The contacts application 108 may be implemented as an address book, or a list of contacts formatted electronically as a database like many known address books or electronic Rolodexes that are well known in the art. When the contacts application 108 is launched, or initialized for operation, the display device 102a may be controlled to present a display of the list of contacts as shown in FIG. 1.

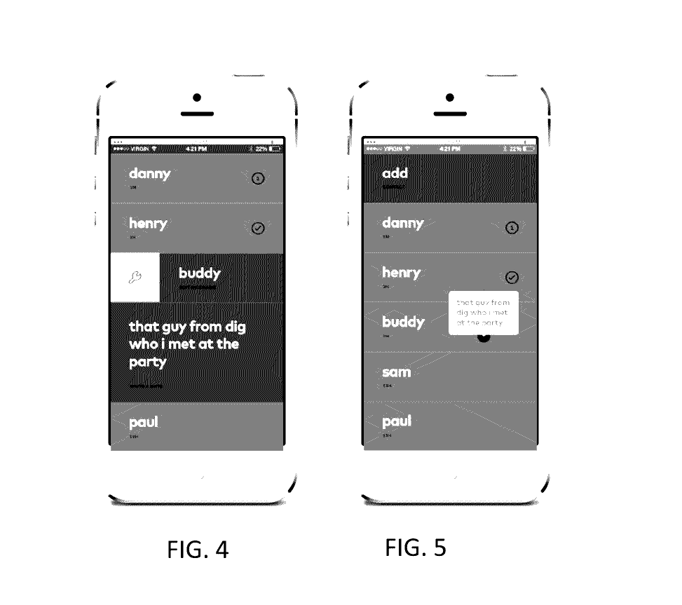

The contacts application 108 illustrated in FIG. 1 allows for the user to enter a nickname to replace the username for a selected contact such that whenever the contact's information is displayed on the display device 102a, the nickname appears instead of the contact's actual name. The contacts application 108 may also be configured to operate in a secure messaging context. In the secure messaging context, selected contacts in the contacts application 108 may be designated as “members” of a secure messaging environment, or as anonymous contacts, i.e. contacts that have in some way indicated a desire to remain substantially anonymous for purposes of communicating messages with the user. In this way, information for anonymous contacts that are listed on the display would appear limited to no more than a nickname or at most to information that would not identify the contact. The information for the anonymous contact may be stored in the contacts database using encryption or other secure means used in securing data from a backend. However, the information displayed about the anonymous contacts may be extremely limited so as to maintain anonymity should the information be captured on the display. The contacts application 108 in FIG. 1 may provide a feature described below with reference to FIGS. 4 and 5 that provides a user with information indicating a context for the contact to allow the user to identify the contact.

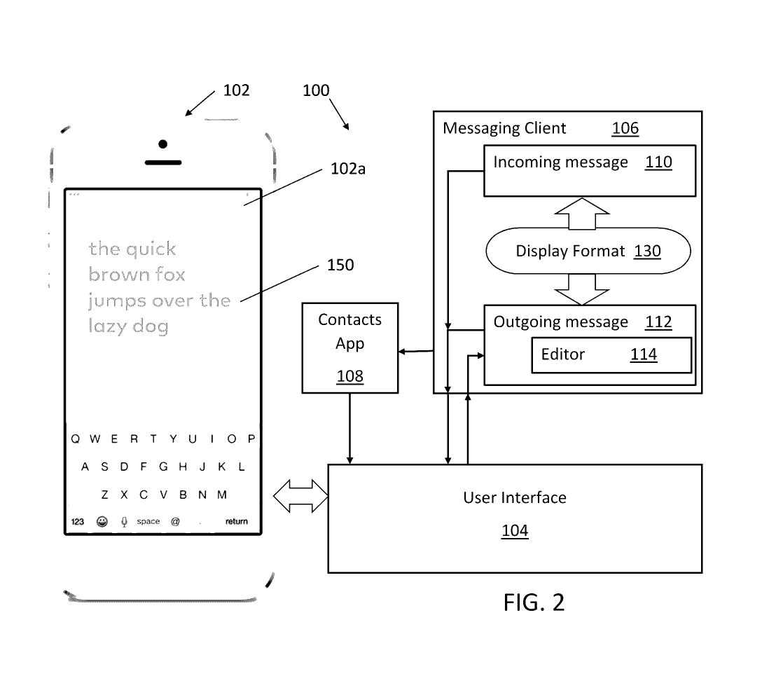

The contacts application 108 in FIG. 1 also provides a message indicator 140 next to the nickname of the sender user that sent a new message. The message indicator 140 may be any suitable graphical image, or icon sized for placement within an area of display having the nickname of the sender user so as to serve the purpose of “tagging” the nickname. The message indicator 140 may be programmed to transfer control to a different application such as the messaging application 106 in order to display the new message received. FIG. 2 is a schematic diagram of the example messaging system 100 in FIG. 1 displaying a message 150 on the computing device. When the user selects or clicks on the message indicator 140 (in FIG. 1), the display 102a may show the new message as illustrated in the display device 102a in FIG. 2. If the sender user is a “member” of a secure messaging community online, or otherwise is an anonymous contact, the message in FIG. 2 is displayed with no information that might identify the sender user. In an example implementation, the message itself is the only information on the display.

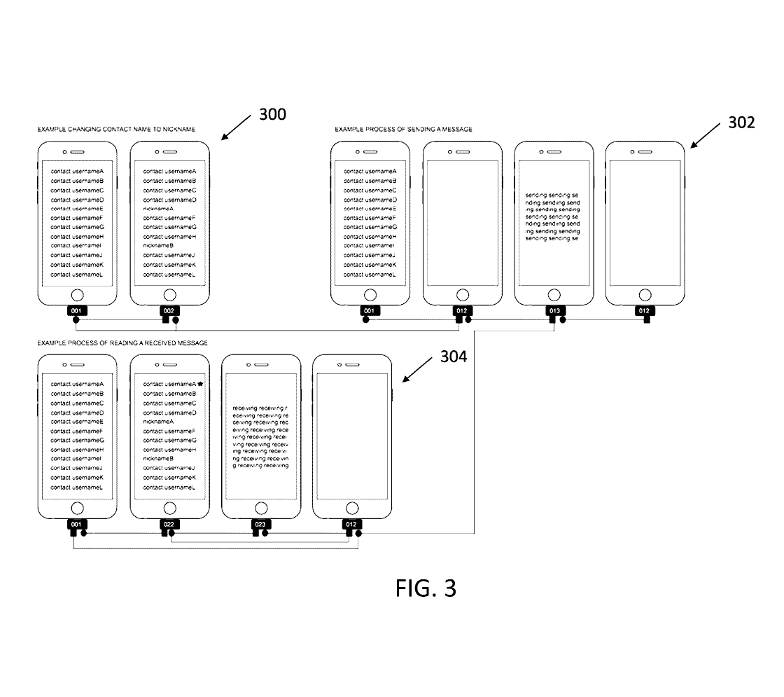

FIG. 3 is a flow diagram illustrating operation of an example implementation of the messaging system 100 (in FIGS. 1 and 2). The flow diagram includes a first user options 300, a second user options 302, and a third user options 304. When a user launches the contacts application 106 (in FIGS. 1 and 2), or takes an action that launches the contacts application 106, the display device is controlled to show an image of a contacts list as shown in display 001 in the first user options 300. The display shows a list of contact usernames: contact usernameA through contact usernameL. The list schematically reflects the contacts list with all contact indicated by the username, which indicates the contact user's identity.

From the contacts list in display 001 in the first user options 300, the user may select an option to edit the user's username for display to a nickname. The user may touch the screen at an area with an image indicating a function that presents a text entry box and images of keys to allow the user to enter a nickname. The user may edit any or all usernames. When the user has finished entering the nickname, the display shows the contact list with the nicknames entered by the user replacing the usernames of the contacts for whom nicknames were provided. In FIG. 3, display 002 shows the contact list with NicknameA entered for the user “contact usernameE” and NicknameB entered for “contact usernameI.”

From the contacts list in display 001 in the first user options 300, the user may perform an action to compose a message to send to a selected user. The user may select the nickname or the username by touching the screen at the name on the contact list, shown for example at either display 001 or display 002 in the first user options 300. The display will change to an editing image as shown in display 012 in the second user options 302. Display 012 is blank. The editing image may include a cursor at the position where the next character entered will be displayed. The user may also touch the screen or swipe the screen or perform some other suitable action to present the image of a keypad. The user may then compose an outgoing message, which appears as shown in display 013 in second user options 302. The outgoing message is displayed using the same format as used to display any incoming messages so that display 013 cannot be distinguished as either an incoming message or outgoing message by its appearance. In addition, the outgoing message in display 013 does not display any information that would identify the user to whom the message is to be sent, nor the user that composed the message. From display 013 in the second user options 302, the user may take an action that sends the composed message upon which the display is changed so that the message is no longer on the display as shown in display 012 in the second user options 302.

From display 001 in the third user options 304, which displays the contact list, a user may receive a message from one of the contacts in the list. The display is changed to a contact list with a message indicator next to the user name that is the sender of the new message as shown in display 022 in the third user options 304. When the user performs an action indicating an instruction to display the new message, the display turns to display 023, which displays the message with no information identifying the sender username and where the new message is displayed with the same message display format used to display the outgoing message in display 013 in the second user options 302. From display 022, the user may also select another username other than the one for which a new message is indicated, which would change the display to one in which a new outgoing message is to be composed as shown in display 012 in the third user options 304. Display 012 in the third user options 304 may switch to display 013 in the second user options 302 if the user composes an outgoing message as described above.

FIGS. 4 and 5 illustrate operation of a feature that allows a user to identify a user identified by only a nickname in the contacts list. The user may select an operation, such as a settings option, that opens a text edit box for a user to enter a note or some phrase or sentence that the user associates with the identity of the user with the nickname. As shown in FIG. 4, the user enters the text: “that guy from dig who I met at the party” to identify the user behind the nickname “buddy.” In FIG. 5, the user may touch an icon or image representing an identify function that pops up the note entered for “buddy” when the user wants to identify the user behind the nickname “buddy.”

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A method for displaying messages on a display device operating in a computing device having a processor, the method comprising:
receiving an incoming message for display on the display device;
identifying a sender username of a sender of the incoming message by searching for a username identifier in the incoming message;
searching a contacts list stored in memory connected to the computing device for a username matching the sender username, the contacts list comprising a plurality of contacts comprising a contact username editable to be changed to a nickname by the user of the computing device;
retrieving a nickname corresponding to the sender username;
displaying a message notification on the display device indicating the user has a incoming message from the sender identified by the nickname;
receiving a user input indicating a display instruction to display the incoming message;
displaying the message without displaying any information identifying the sender username, where the message is displayed using a message display format that is used for a message editor display when the user of the computing device edits a message;
receiving a user input to change the display from displaying the incoming message; and
deleting the incoming message when the display is changed from displaying the incoming message.

2. The method of claim 1 where in the step of receiving the message, the message is encrypted, the method further comprising the step of decrypting the encrypted message.

3. The method of claim 1 further comprising:
receiving a user input indicating a display instruction to display the message editor screen for entry of an outgoing message;
displaying the message editor screen using the message display format that was used to display the incoming message so that the outgoing message appears identical to the incoming message.

4. The method of claims 3 further comprising:
receiving a user input indicating a send instruction to send the outgoing message.

5. The method of claim 3 further comprising encrypting the outgoing message before sending the message.

6. The method of claim 1 further comprising:
receiving a user input indicating a display contact list instruction to display the contact list;
displaying at least a portion of the contact list on the display device.

7. The method of claim 6 where at least one of the usernames in the contact list is identified as a privacy app user identifiable by the user-editable nickname, the method further comprising:
displaying the nickname of the privacy app user on the displayed contact list.

8. The method of claim 6 where the step of displaying the message notification on the display comprises:
displaying a message received image in a field of the display that includes the nickname of the sender username.

9. The method of claim 1 where the message display format used for display of the message editor display and incoming messages includes an animation setting.

10. The method of claim 7 further comprising:
displaying an instruction to enter an address of a user not a privacy app user;
sending an invitation to become a privacy app user to the user at the address entered by the user.

11. The method of claim 6 further comprising:
displaying for each nickname on the contact list, a nickname context message indicating a context for the nickname that allows the user to remember the identity of the user.

12. A messaging system operating on a computing device having a processor, the messaging system comprising:
a user interface connected to a display device configured to display images and text;
a messaging application configured to receive incoming messages and a message editor for preparing outgoing messages, to provide the incoming messages and the message editor display using a message display format that displays incoming messages and outgoing messages with the same format and appearance, where incoming and outgoing messages are displayed without displaying any information identifying a sender of the incoming message or a username of the user, and where incoming messages are deleted when the messaging application receives a user input that changes the display; and
a contacts application configured to provide an image to display contact entries by either username, or by a nickname editable by the user to replace the username in the display of the contact entries.

13. The messaging system of claim 12 where the contacts application is further configured to provide an indication of an incoming message for a nickname corresponding to a sender username.

14. The messaging system of claim 12 where the contacts application is further configured to display a user-editable nickname context message for a corresponding user-editable nickname.

15. The messaging system of claim 12 further comprising:
a user profile comprising user information in a data structure accessible by the messaging application and the contacts application.

16. The messaging system of claim 15 where the user profile comprises a personal identification number editable by the user and used by the user to enter when requested for access to the messaging system.

17. The messaging system of claim 16 where the user profile comprises a second personal identification number editable by the user and used to operate the messaging system using a counterfeit user profile.

18. The messaging system of claim 15 where the user profile comprises a message expiration timer editable by the user to set a time duration that a selected message is indicated in a user's contact list before it is automatically deleted.
